(19) United States
(12) Patent Application Publication
(10) Pub. No.: US 2010/0052853 A1
(43) Pub. Date: Mar. 4, 2010

(54) CONTROLLING AN ELECTRONIC DEVICE BY WAY OF A CONTROL DEVICE

(75) Inventor: David Gareth Hilton, West Yorkshire (GB)

Correspondence Address: EchoStar Technologies, L.L.C.;Legal Department, 9601 SOUTH MERIDIAN BOULEVARD, ENGLEWOOD, CO, 80112, US

(73) Assignee: Eldon Technology Limited, Steeton (GB)

(21) Appl. No.: 12/203,286

(22) Filed: Sep. 3, 2008

(51) Int. Cl. G05B 19/00

(52) U.S. Cl. 340/5.83; 340/5.82

(57) ABSTRACT

A remote control device for a set top box has a biometric reader, such as a fingerprint reader, incorporated therein. During installation of the set top box, fingerprint data is collected from users who are to be authorised by way of the fingerprint reader and is stored in the set top box. When using the remote control device to access programming, fingerprint data is collected from the user and compared with the stored data to determine if the user is authorised. The user has to be authorised to access some, or even all, of the programming. Access to subscription only services and to pay per view programmes is only available to a user identified by the set top box as being authorised. Electronic devices other than set top boxes, for example audio devices and computers, can similarly be controlled by a control device incorporating a biometric reader.

The present invention relates to a control device for an electronic device, a method of controlling an electronic device using a control device, and an electronic device in conjunction with its control device.

### BACKGROUND TO THE INVENTION

Television receivers are controlled by digital devices, often referred to as set top boxes (STBs), which receive and process transmissions from broadcasters. The user has a control device, often a remote control device, to control the set top box, and hence the television receiver.

With a set top box, it is common to provide a smart card, known as a viewing card, which is issued to an authorised user of various services. The smart card has to be inserted into the set top box to enable access to some, or all of the programming. For example, the smart card may be required to enable access to services only available by subscription, and/or to pay per view individual programmes. A processing unit in the set top box will read information from the viewing card to enable access to services. The viewing card may, for example, identify a subscriber account, and if the appropriate payments have been made to that subscriber account, access is enabled.

It is also known to pair the viewing card with a particular set top box. Thus, on installation of a set top box at the home of an authorised subscriber, details from the subscriber's viewing card are stored in the set top box. Thereafter, the set top box will only allow the television receiver to access some, or all, programming if the paired viewing card is in place in the set top box.

Many set top boxes enable users to control the programming which can be displayed. For example, a user can set up their set top box such that adult programming is only available if a password is provided by way of the control device. Typically this password is a four digit pin number. This enables a parent, for example, to allow their children to watch television safe in the knowledge that their children will not gain access to films which are rated for adults only, nor to other content thought unsuitable for children.

In a totally different field, fingerprint readers, and other biometric readers, are available for collecting biometric data from individuals. It is known to use a fingerprint reader to provide password information. For example, it is known to connect a fingerprint reader to a computer. When a program, such as an access program to a bank account, asks for identification, fingerprint characteristics read by the fingerprint reader can be used instead of inputting a password made up of letters and numbers, or entering a pin number. Such systems are used so that the user of the computer does not need to remember different passwords for different applications, and avoids the risks inherent in using the same password for different applications.

### SUMMARY OF THE PRESENT INVENTION

This invention began from a consideration of the control of a set top box, and seeks to provide a control method for an electronic device which is more flexible, and which is capable of embracing more applications, than is currently available.

According to a first aspect of the present invention there is provided a control device for an electronic device incorporating a processing unit,

the control device being arranged to issue commands to control the operation of the electronic device by way of the processing unit,

wherein the control device incorporates a biometric reader arranged to collect biometric data from a user and to provide the collected biometric data to the processing unit of the electronic device so that it can be determined if the user is authorised to operate the electronic device.

A control device of the invention differs from a fingerprint reader connected to a computer, for example, in that the control device controls the operation of the electronic device and is not used only to provide fingerprint data to act as a password to an external application.

A control device of an embodiment of the invention may be wired to, incorporated within, or remote but in communication with, the electronic device, and is arranged to enable an authorised user of the electronic device to be identified by the biometric data collected.

In one embodiment, the biometric reader incorporated within the control device is arranged to determine a biometric signature of the user which is provided to the processing unit of the electronic device for comparison with the biometric signatures of authorised users.

Alternatively, the biometric reader incorporated within the control device may be arranged to authenticate the user's identity from the biometric data collected and to provide the identity to the processing unit of the electronic device.

The biometric reader of the control device of an embodiment of the invention is able to provide information to identify a user, and the electronic device can compare that identity with lists of authorised users stored either locally in the electronic device or remotely. It can be arranged that only users who are found to be authorised are able to control the operation of the electronic device. Alternatively, it can be arranged that access to a subset of operations of the electronic device is only available to authorised users.

The invention was developed with reference to the control of a set top box for a television receiver. The control device of the invention can be arranged, for example, to allow anyone to operate the set top box to access free to air programming, whilst an authorised user has to be present to access other programming. Alternatively, an authorised user may have to be present to provide biometric data to the control device to enable any programming to be shown on the television receiver.

Because the control device collects biometric data, it collects information as to which one, for example, of a number of authorised users, is actually controlling the set top box or other electronic device. This information, which, for example, is not available from a viewing card, can be used to acquire information as to the usage by individual users either for billing purposes or to provide different resources to different users. For example, where the set top box of a television receiver has the ability to store a menu of favourite viewed channels, the control device can enable information about the viewing habits of different users to be collected, such that the set top box can store individual menus of favourite channels for different authorised users.

The biometric reader incorporated within the control device can be any reader suitable for collecting biometric data from a user. For example, existing biometric readers can examine the iris of the eye or collect a user's DNA. However, given that a traditional remote control device for a set top box has push buttons which are operated by a user's fingers, it is convenient to provide, as at least one biometric reader within the control device, a fingerprint reader.

Available fingerprint readers usually have a fingerprint pad which is pressed by the user utilising a designated finger. In the context of a remote control device it would be possible, for example, to provide the fingerprint pad within the upper surface of the remote control device. As a user will normally grasp the remote control device within their hand, it could additionally and/or alternatively be useful to have the fingerprint pad within the lower surface of the control device.

In another alternative embodiment, the fingerprint pad may be provided on a sliding platform generally housed within the remote control device but extendible outwardly to make the fingerprint pad accessible when required.

It has been noted that in a particularly useful embodiment of the invention, a biometric reader is incorporated within a remote control device for a set top box for a television receiver.

In such circumstances, biometric data read from the user by the biometric reader in the remote control device may be compared with biometric data of authorised users stored within the set top box to control access by the set top box to particular programming.

It is known to pair a set top box with a viewing card such that the set top box can only be used when the paired viewing card is present. It is possible with the present invention to pair the identity of an authorised user with the electronic device, for example, to pair biometric data from one or more authorised users with identities stored in the set top box.

The present invention also extends to a method of controlling an electronic device incorporating a processing unit and storage, operation of the electronic device being controllable by the processing unit in accordance with commands received from a control device, the method comprising:

collecting biometric data from a user by way of a biometric reader in the control device,

utilising the collected biometric data to determine whether the user is authorised, and

enabling selected operations of the electronic device only when it is determined that the user is authorised.

To communicate with the electronic device, the control device may be wired to, or incorporated within the electronic device. Alternatively, the control device may be remote, but in communication with, the electronic device by way of appropriate transmission means.

Any appropriate transmission means to enable the control device to communicate wirelessly with the electronic device may be used. For a set top box, for example, the communication is usually by way of infrared or radio frequencies.

In an embodiment, the method comprises

causing the biometric reader in the control device to determine a biometric signature of the user and to provide the determined biometric signature to the electronic device.

Additionally and/or alternatively, the method may comprise

causing the biometric reader in the control device to authenticate the user's identity from the biometric data collected and to provide the identity to the electronic device.

A method of an embodiment may comprise

causing the biometric reader of the control device to provide to the electronic device information to identify a user, and

the electronic device comparing that identity with lists of authorised users stored either locally in the electronic device or remotely.

In an embodiment, the method comprises

storing in the storage in the electronic device the biometric data of authorised users, and

causing the processing unit of the electronic device to compare the stored biometric data with the biometric data collected from a current user by the biometric reader of the control device.

Additionally and/or alternatively, the method may comprise

enabling the electronic device to interrogate a remote server to obtain the biometric data of authorised users, and

causing the processing unit of the electronic device to compare the obtained biometric data with the biometric data collected from a current user by the biometric reader of the control device.

It can be arranged that only users who are found to be authorised are able to use the control device to control the operation of the electronic device. Alternatively, it can be arranged that access to a subset of operations of the electronic device is only available by way of the control device to authorised users.

The invention was developed with reference to the control of a set top box for a television receiver. The control device can be arranged, for example, to allow anyone to operate the set top box to access free to air programming, whilst an authorised user has to be present to access other programming. Alternatively, an authorised user may have to be present to provide biometric data to the control device to enable any programming to be shown on the television receiver.

The control device may provide conditional access to some or all operations of the electronic device in dependence upon the identity or authorisations of the current user.

In its simplest form, and irrespective of whether the biometric data of authorised users has been stored locally or at a remote server, the method may further comprise:

as a result of the comparison, determining if the current user is an authorised user, and

where the current user is identified as authorised, enabling control of the operation of the electronic device by way of the control device.

The invention may also extend to methods of providing conditional access to an electronic device incorporating a processing unit and controlled by a control device having a biometric reader associated therewith.

In one such conditional access method, a user may be identified as an administrator level authorised user on initialisation, and given the ability to provide access, in a controlled manner to others.

The method may further comprise collecting information as to which one of a number of authorised users is currently controlling operation of the electronic device by way of the control device and using the collected information to determine a usage profile for individual users.

The usage profiles may be utilised for billing purposes or to provide different resources to different users. For example, the electronic device may be enabled to store individual menus of favourite channels for different authorised users.

The biometric reader incorporated within the control device may be any reader available to collect biometric data from a user. It is convenient to have, as at least one biometric reader within the control device, a fingerprint reader.

Methods of the invention may control the set top box for a television receiver by a remote control device.

Using this method, when the electronic device and its control device are initialised originally, biometric data of authorised users will need to be read and stored in the electronic device.

In an alternative embodiment, a method of the invention comprises enabling the electronic device to interrogate a remote server to obtain biometric data identifying authorised users, and causing the processor unit of the electronic device to compare the biometric data of identified authorised users with the biometric data collected by the biometric reader of the control device.

The remote server in this embodiment, for example, may be the head end of a broadcasting system. This ability to seek identifying biometric data from a source external to the electronic device is useful, for example, where service engineers need to operate an electronic device in a domestic home.

According to a further aspect of the present invention there is provided an electronic device incorporating a processing unit and storage, in combination with a control device arranged to issue commands to control the operation of the electronic device by way of the processing unit, wherein the control device incorporates a biometric reader arranged to collect biometric data from a user and to provide the collected biometric data to the processing unit of the electronic device so that it can be determined if the user is authorised to operate the electronic device.

The control device provided in combination with the electronic device may be wired to, incorporated within, or remote but in communication with, the electronic device, and the control device is arranged to enable an authorised user of the electronic device to be identified by the biometric data collected.

In a preferred embodiment, the biometric reader is a fingerprint reader.

Preferably, the fingerprint reader has a fingerprint pad within a surface of the control device.

Available fingerprint readers usually have a fingerprint pad which is pressed by the user utilising a designated finger. In the context of a remote control device it would be possible, for example, to provide the fingerprint pad within the upper surface of the remote control device. As a user will normally grasp the remote control device within their hand, it could additionally and/or alternatively be useful to have the fingerprint pad within the lower surface of the control device.

In another alternative embodiment, the fingerprint pad may be provided on a sliding platform generally housed within the remote control device but extendible outwardly to make the fingerprint pad accessible when required.

In a particularly useful embodiment of the invention, the control device is a remote control device and the electronic device is a set top box for a television receiver.

It will be well understood that what is known as a set top box is a digital device which may be built in or integrated into a television receiver or may be provided as, or within, a separate device. The present invention comprehends all digital devices for giving a TV receiver functionality whether they are provided separately, in combination with other control circuits and devices, and/or whether they are integrated within the television receiver.

If required, the identity of an authorised user may be paired with the set top box. This enables the remote control device to be uniquely paired to the set top box in that biometric data collected by way of the biometric reader in the remote control device has been stored in the set top box to identify the authorised user.

### BRIEF DESCRIPTION OF THE DRAWINGS

Preferred embodiments of the present invention will hereinafter be described, by way of example, with reference to the accompanying drawings in which:

FIG. 1 shows schematically the provision of programming by way of a set top box to a display on a television set,

FIGS. 2a and 2b show a side view and a top view of one embodiment of a remote control device for use in controlling the set top box of a television receiver,

FIGS. 3a and 3b show a side view and top plan view of an alternative remote control device,

FIGS. 4a and 4b show a side view and a top plan view of yet an alternative embodiment of a remote control device in a rest condition,

FIGS. 5a and 5b show a side view and a top view of the remote control device of FIGS. 4a and 4b showing the device in a condition in which fingerprint data of the user can be collected,

FIG. 6 shows a menu to be displayed on a television screen when different authorised users are to be given different access to programming,

FIG. 7 shows a subsequent menu, chosen from a hierarchical set of menus, for a program to give different authorised users differing degrees of access to programming, and

FIGS. 8, 9 and 10 illustrate the differing levels of access available.

### DESCRIPTION OF PREFERRED EMBODIMENTS

This invention arose from a consideration of the control of a set top box for a television receiver and is described further below specifically with reference to that context. However, a control device as described herein can be utilised to control electronic devices other than set top boxes for television receivers. For example, the invention may be used to provide control by an authorised user only of an audio player, a computer, or other electronic device.

Throughout the specification we refer to the control of a set top box for a television receiver. However, it will be understood that the set top box comprehends any digital device able to impart functionality to the television receiver whether provided in a stand-alone box, incorporated in a stand-alone box along with other devices, or integrated within the television receiver.

Conveniently, particularly in the context of a television receiver, the control device is a remote control device communicating with the set top box by wireless means. It will be appreciated that any appropriate transmission method to enable the remote control device to communicate with the electronic device may be employed. For television receivers the remote control device will normally communicate with the set top box either via infrared or via radio frequencies.

Whilst, for the television context, the control device is usually remote from the set top box or other electronic device to which it provides commands, the present invention also covers arrangements in which the control device is wired to the electronic device it commands, and/or is incorporated within the electronic device.

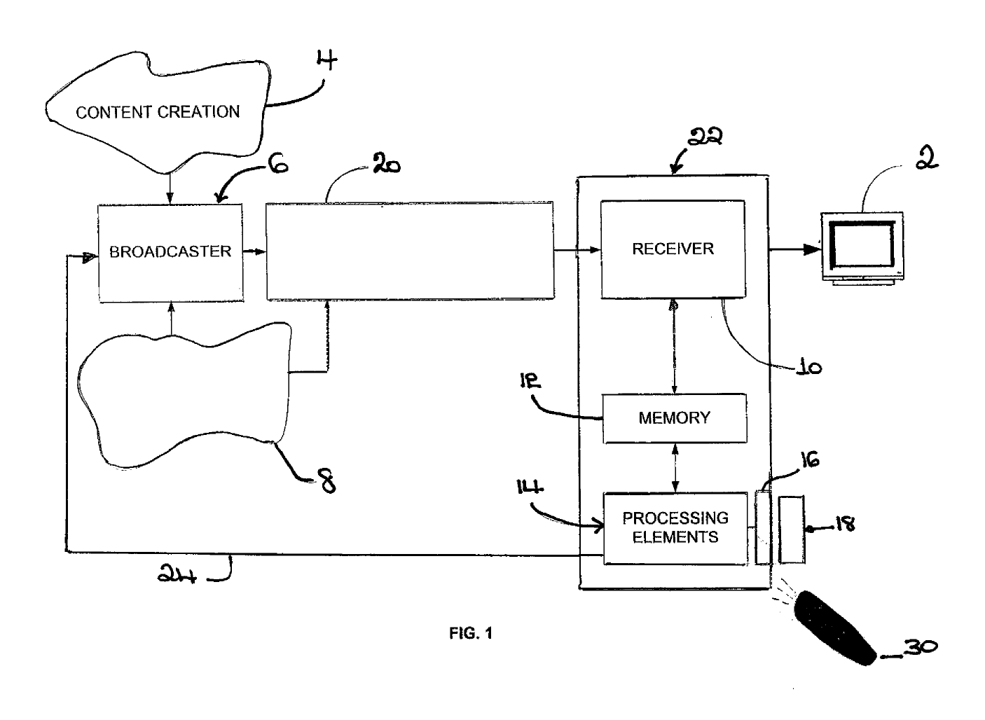

FIG. 1 shows schematically the provision of programming by way of a set top box 22 to a television receiver 2. Programming content, that is video and audio data, is created as indicated at 4 and is provided to a network provider or broadcaster 6 for transmission. The video and audio content 4 is combined for transmission with information and control data 8. This information and control data 8 may include teletext information, and other material, including data, such as graphics, for display. The information and control data 8 also incorporates data to command and control operation of the set top box 22 and the TV receiver 2. For example, the control data 8 may require the set top box to interrogate a viewing card to check authorisations. Information required by the set top box, such as identity information is also included.

The information and control data may be supplied to the broadcaster 6 for combination with the programming content 4 or it may be fed separately to a multiplexer 20 which is arranged to packetise and multiplex the programming content and the information and control data into a transport stream in accordance with the appropriate standards. It is this material which is then transmitted by any appropriate means to a set top box 22. As is well known, the set top box includes a receiver 10 for receiving the transmitted programming, a memory 12 and a processing unit 14. The processing unit has a card reader 16 in which a viewing card 18 can be inserted. Operation of the set top box 22 is controlled by a remote control device 30 which is in communication with the processing unit 14 of the set top box 22 by ways for example, of infrared communication.

The set top box 22 is also arranged to communicate with the broadcaster 6. For example, and as illustrated, there may be a telephonic connection 24 between the processing unit 14 and the broadcaster 6. This communication between the set top box 22 and the broadcaster 6 can be two-way to enable, for example, the set top box to obtain from the broadcaster information and control data 8 indicating whether or not the subscriber's account identified on the viewing card 18 is up to date.

In many current systems, the viewing card 18 identifies a subscriber account. If, on operation of the remote control device 30 to access programming, the set top box 22 determines by way of its processing unit 14 that the subscriber account has had appropriate payments made such that the programming can be accessed, it will cause the requested programming to be displayed on the television receiver 2. It is possible to store the permissions associated with the subscriber account in the memory 12 of the set top box and/or to pair the viewing card 18 with the set top box. In this latter case, the set top box 22 can only provide programming to the receiver 2 when the paired viewing card 18 is in place.

In accordance with the present invention, the remote control device 30 has an integrated biometric reader incorporated therein. The information obtained by the biometric reader can be used additionally and/or alternatively to the information on the viewing card 18 to enable access by a viewer to particular programming.

The biometric reader may be any reader suitable for collecting biometric data from the user. Currently, readers able to identify a user by iris recognition are available, as are readers able to collect DNA. There are also facial feature recognition systems. However, given that the common remote control device is operated by a user's fingers, it is currently preferred that the biometric reader be a fingerprint reader. The fingerprint reader may be enabled to capture appropriate fingerprint characteristics and transmit them to the processing unit for comparison with stored characteristics, or it may be arranged itself to compare collected characteristics against stored data to identify the user and then to transmit the user's identity to the processing unit 14.

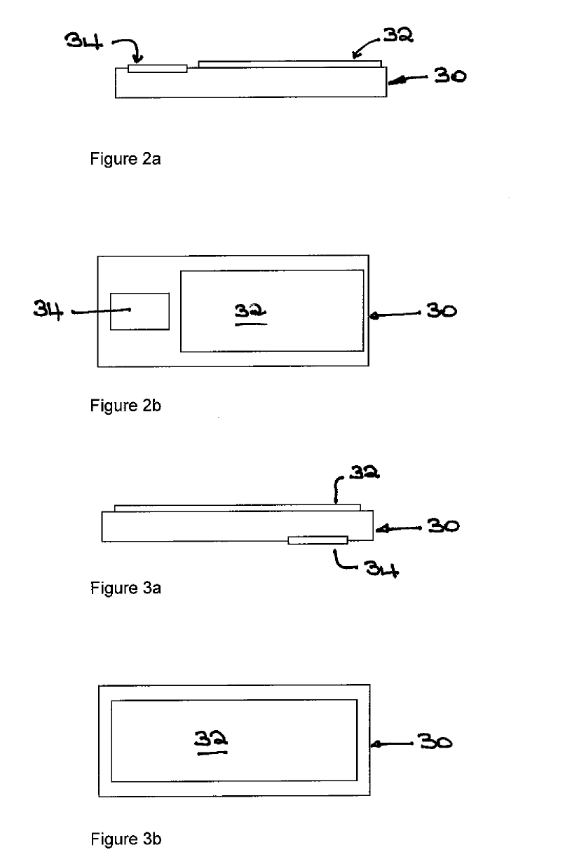

A fingerprint reader generally has a fingerprint pad against which a designated finger of a user is pressed. FIGS. 2a and 2b show schematically a first embodiment of a remote control device 30 in which a fingerprint reader is incorporated. In this embodiment, the remote control device 30 has, on its upper surface, a collection of push buttons within an area 32. A fingerprint pad 34 of the fingerprint reader is also provided within the upper surface of the remote control 30.

It is usual to pick up a remote control device in the whole hand and it would also be convenient to provide a fingerprint pad 34 on a lower surface of the device 30 as is shown in FIGS. 3a and 3b. In the embodiment shown in FIGS. 3a and 3b, the remote control device 30 again has an area 32 on its upper surface in which the usual pushbuttons are provided. In this embodiment, the fingerprint pad 34 is provided within the lower surface of the remote control device 30.

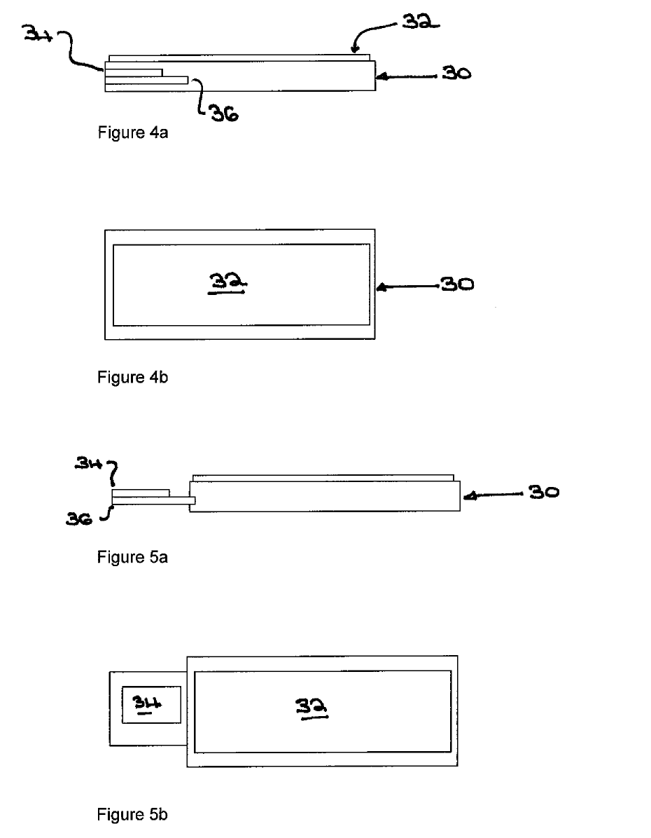

FIGS. 4a and 4b, and 5a and 5b show side elevations and top plan views of an embodiment of a remote control device 30 having a slidable platform to carry the fingerprint pad 34 of a fingerprint reader The arrangement is shown in a closed or rest position in FIGS. 4a and 4b. As previously, the remote control device 30 has an area 32 on its upper surface in which push buttons are provided. There is also a fingerprint pad 34 of the fingerprint reader, but in this embodiment, the fingerprint pad is provided on a slidable platform 36 which, in the rest position is withdrawn into the remote control device 30. When the fingerprint reader is required, the platform 36 is extended as indicated in FIGS. 5a and 5b such that the fingerprint pad 34 is accessible.

The fingerprint reader within the remote control 30 is controllable to collect fingerprint characteristics from a user of the remote control device 30. As indicated earlier, the fingerprint reader is arranged to transmit fingerprint data, or the identity of an authorised user, to the processing unit 14 of the set top box 22.

It will be appreciated that there are many ways in which the fingerprint identification can be used. Thus, all access to programming by way of the set top box may require that the remote control device be operated by an authorised user. Alternatively, any pay per view programming, or other programming available by subscription, may require that the operator of the remote control device to be authorised, whilst free to air programming is available for any operator.

When the set top box 22 is originally installed in a user's home, one or more members of the household who are to become authorised users of the set top box will be asked, in turn, to apply a finger to the fingerprint pad 34 of the fingerprint reader as part of the installation process. During the installation, the fingerprint reader collects fingerprint data from each user and either stores that data in the fingerprint reader as an authorised identity or transmits the fingerprint characteristics to the processing unit 14 of the set top box 22. The processing unit 14 stores the fingerprint characteristics, or the identity, of each user who has been authorised during installation.

Whenever the set top box 22 is switched on from the mains, or taken out of standby, it can cause a request to be displayed on the screen of the television receiver 2 asking the user to provide fingerprint data. The user then applies the designated finger onto the fingerprint pad 34 of the remote control device 30. The set top box 22 will enable viewing if the identity or fingerprint characteristics transmitted by the remote control device 30 to the set top box 22 are found to match with the stored information. The processing unit 14 will undertake a comparison routine to determine if the fingerprint data matches the stored data. If there is no match, either viewing is disabled, or a warning is displayed that only selected programming, say free to air programming, is available.

Generally, the information about an authorised user will be stored locally, for example, in the memory 12 of the set top box 22. However, as the set top box 22 is in communication with the head end, for example at the broadcaster 6, the information can be stored at a remote server associated with the broadcaster 6. It is particularly important to enable the processing unit 14 of the set top box 22 to make a comparison between the fingerprint data collected from the remote control device 30 and data stored remotely where it is required to enable use of the set top box and the TV receiver by way of service engineer.

It would be additionally and/or alternatively possible to store the fingerprint information of authorised users on the viewing card 18. Currently, set top boxes can be paired to their viewing cards so that a particular set top box can only be used when the paired viewing card 18 is inserted. It would be similarly possible to pair the fingerprint data of authorised users with the set top box. Additionally and/or alternatively, the biometric data collected, for example, the fingerprint data, could be paired to a viewing card.

Different users of the remote control device 30 can be authorised at different levels. For example, service engineers would be given the highest rights. It could be required that all authorised users in a household be so authorised at the initial installation and setup of the set top box 22. Then further users will need to contact the broadcaster or network provider to obtain the necessary authorisations. Additionally and/or alternatively, some or all users can be given the right to add other users and/or to restrict the viewing of others.

So, for example, during initialisation of a set top box, a single authorised user may be identified. However, that authorised user might be enabled to add other authorised users. Thus, one member of the household, present when the engineer installs the set top box, can be authorised by having his fingerprint characteristics collected and appropriately stored. When other members of the family are present, that authorised user could undertake routines to add other authorised users. In such a circumstance, the prior authorised user will commence an authorisation routine using the remote control device 30 to take the authorisation routine through stages as identified by sets of hierarchical menus on the screen of the television receiver 2. Start of the routine will require the authorised user to give his fingerprint and the routine only continues if his fingerprint is identified as being authorised. The subsequent user is then asked by way of on screen instructions to apply a finger to the fingerprint pad 34 so that fingerprint data can be collected and stored in the set top box 22, whereby the subsequent user is authorised in his turn.

It is well known for the processing unit 14 of a set top box 22 to provide sets of hierarchical menus, which are displayed on the TV screen, to guide a user through various programs and routines to access programs, store information and recordings, and to change settings. Comparable routines and programs, which will be apparent to those skilled in the art, would be provided to enable fingerprint data from users to be authorised to be collected, and to enable authorisations to be required, and checked. Similarly, the further functionality described below can be provided by appropriate routines and programs, which will be apparent from consideration of that functionality.

Currently, access to programming can be controlled by the use of passwords or pin numbers. Thus, the network provider or a parent can set up a set top box to require a pin number to be entered if the programme content is not suitable for children. Thus, children viewing alone who try to view an adult rated film, for example, are asked to insert a pin number, which they do not have. They are thus denied access to the content. Unfortunately, if they forget the pin number, the parents are also denied access to adult content, and children have been known to hack the pin system.

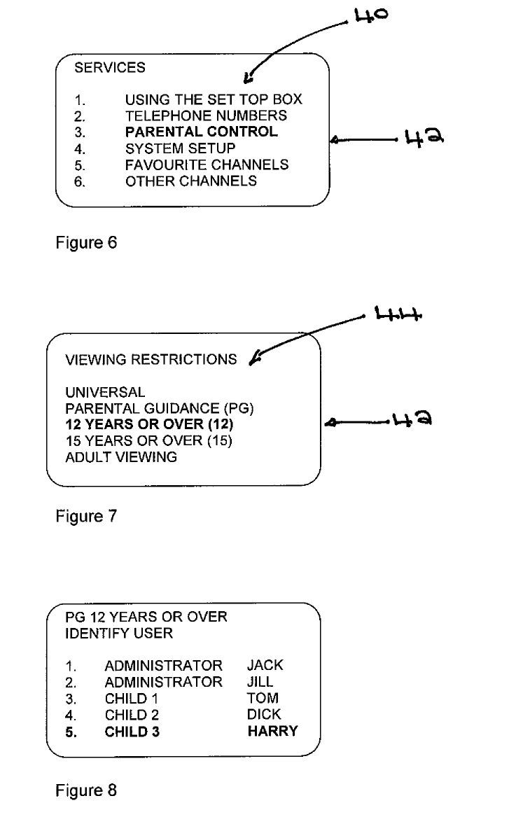

The present invention enables all members of a household to easily access the programming to which the household has determined they are entitled. The authorisation of individuals with differing viewing rights is illustrated in FIGS. 6 to 10 which show some of the menu options displayed on the screen of the television receiver 2 during the setup of viewing restrictions. Thus, FIG. 6 shows the hierarchical menu 40 displayed on the screen 42 of the television receiver 2 when a parent wishes to set different levels of access for different children. In FIG. 6 a services menu is displayed including the item: “3. PARENTAL CONTROL”. The parent setting up the system will highlight the menu item “parental control” and press an ‘ok’ or ‘select’ button on the remote control device 30. This can bring up an identification routine in which the parent will be asked to place the designated finger on the fingerprint pad 34 of the remote control device 30. The parent's identity having been compared in the processing unit 14 of the set top box 22, and the parent having been identified as an authorised user, with appropriate rights, a viewing restriction menu 44 will be displayed on the screen 42 as shown in FIG. 7. In this example, the parent wishes to allow access to child 3, Harry, to content suitable for children aged 12 years or over. That category of content is highlighted and entered from menu 44 by use of the remote control device 30. This brings up a menu, for example as shown in FIG. 8, in which all persons already identified to the remote control device 30 are listed. If child 3, Harry, is then selected, he will be given access to programming suitable for children 12 years or over, to content requiring parental guidance, and to universal content. However, child Harry will not, when operating the remote control device 30 be able to access programming categorised as 15 years or over, or as adult.

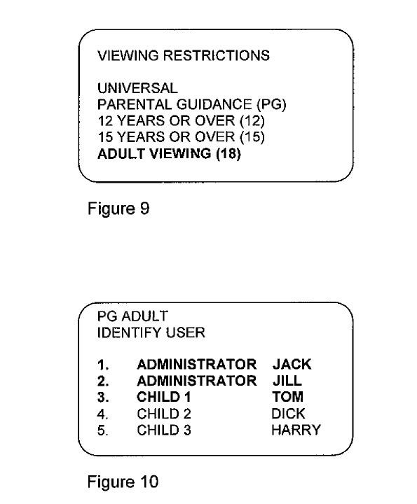

FIGS. 9 and 10 show the persons already identified to the set top box 22 as having access to adult viewing. As shown in FIG. 10 these are two persons, Jack and Jill, identified as administrators and child 1, Tom. The administrators, Jack and Jill, can be given permissions to alter the access levels, for example, as the children get older.

It will be appreciated that various routines may be devised to step through hierarchical menus to set viewing restrictions and other controls as required.

As stated earlier, a service engineer will have the highest access rights and the identification of a user as a service engineer will enable that service engineer to perform menus on the set top box 22 which are hidden from the consumer. Currently, service engineers input a key combination on the remote control device 30 or use a service remote control device to access the hidden functionality. Inputting their fingerprint or other biometric characteristics into the remote control device, preferably for checking at a remote server, is much more secure.

It will be appreciated that users of modern television networks are now enabled to make purchases and perform other transactions by way of the remote control device 30 and the set top box 22. With the user identified and authorised as described herein, such transactions can be made more secure and children, for example, can be prevented from ordering movies or performing other transactions.

The biometric data collected from the user, for example the fingerprint data collected, can be used to encrypt data to be stored in the set top box or indeed in any other electronic device controlled by a control device of the invention.

It is now common to enable a household to arrange for their set top box to store favourite channels for easy access to those channels. With the invention it can be arranged that, at any time, the actual user of the remote control device is identified to the set top box. This enables the favourite channels and other preferences of each individual user of a particular remote control device 30 to be determined and recorded so that each individual user can access their own stored favourites. Furthermore, when a user wishes to access their favourites, it is only necessary for them to identify themselves by placing their finger on the fingerprint pad 34 to have their particular list of favourites displayed.

Each user could hide their list of favourites from the view of others by locking them with their biometric signature.

The broadcaster or network provider 6 can also access information from the set top box 22 identifying viewing habits. As each user can now be identified to the set top box, the viewing habits of individuals, rather than of the household, can be monitored. In addition, the parental control menus could be extended to enable a parent to interrogate the set top box to investigate the viewing habits of a child.

Currently, network providers supply programming which requires viewers to vote. If it is required to provide one vote only per person, for examples to avoid suggestions that supporters of a particular person or act have been voting repeatedly, votes can be taken by having each user who wants to vote use the remote control device 30. The remote control device described herein can ensure that a regime of “one viewer, one vote” can be reliably enforced. The security can be made sufficient to be used for surveys, and local and national elections.

it will be appreciated that variations in and developments of the embodiments as described and illustrated may be made within the scope of the appended claims.

1. A control device for an electronic device incorporating a processing unit,
the control device being arranged to issue commands to control the operation of the electronic device by way of the processing unit,
wherein the control device incorporates a biometric reader arranged to collect biometric data from a user and to provide the collected biometric data to the processing unit of the electronic device so that it can be determined if the user is authorised to operate the electronic device.

2. A control device according to claim 1, wherein the biometric reader incorporated within the control device is arranged to determine a biometric signature of the user which is provided to the processing unit of the electronic device for comparison with the biometric signatures of authorised users.

3. A control device according to claim 1, wherein the biometric reader incorporated within the control device is arranged to authenticate the user's identity from the biometric data collected and to provide the identity to the processing unit of the electronic device.

4. A control device according to claim 1, wherein the biometric reader is a fingerprint reader.

5. A control device according to claim 4, wherein the fingerprint reader has a fingerprint pad within a surface of the control device.

6. A control device according to claim 1, wherein the electronic device is a set top box for a television receiver, and the control device is a remote control device for operating the set top box.

7. A control device according to claim 6, wherein the remote control device is uniquely paired to the set top box in that biometric data collected by way of the biometric reader in the remote control device has been stored in the set top box to identify the authorised user.

8. A control device according to claim 7, wherein the set top box stores a plurality of instances of biometric data collected by the biometric reader, each instance of biometric data associated with one of a plurality of authorised users.

9. A method of controlling an electronic device incorporating a processing unit and storage, operation of the electronic device being controllable by the processing unit in accordance with commands received from a control device, the method comprising:
collecting biometric data from a user by way of a biometric reader in the control device,
utilising the collected biometric data to determine whether the user is authorised, and
enabling selected operations of the electronic device only when it is determined that the user is authorised.

10. A method of controlling an electronic device according to claim 9, comprising
causing the biometric reader in the control device to determine a biometric signature of the user and to provide the determined biometric signature to the electronic device.

11. A method of controlling an electronic device according to claim 9, comprising
causing the biometric reader in the control device to authenticate the user's identity from the biometric data collected and to provide the identity to the electronic device.

12. A method of controlling an electronic device according to claim 9, comprising
storing in the storage in the electronic device the biometric data of authorised users, and
causing the processing unit of the electronic device to compare the stored biometric data with the biometric data collected from a current user by the biometric reader of the control device.

13. A method of controlling an electronic device according to claim 9, comprising
enabling the electronic device to interrogate a remote server to obtain the biometric data of authorised users, and
causing the processing unit of the electronic device to compare the obtained biometric data with the biometric data collected from a current user by the biometric reader of the control device,

14. A method of controlling an electronic device according to claim 12, further comprising:
as a result of the comparison, determining if the current user is an authorised user, and
where the current user is identified as authorised, enabling control of the operation of the electronic device by way of the control device.

15. A method of controlling an electronic device according to claim 13, further comprising:
as a result of the comparison, determining if the current user is an authorised user, and
where the current user is identified as authorised, enabling control of the operation of the electronic device by way of the control device.

16. An electronic device incorporating a processing unit and storage, in combination with a control device arranged to issue commands to control the operation of the electronic device by way of the processing unit, wherein the control device incorporates a biometric reader arranged to collect biometric data from a user and to provide the collected biometric data to the processing unit of the electronic device so that it can be determined if the user is authorised to operate the electronic device.

17. An electronic device and a control device according to claim 16, wherein the biometric reader is a fingerprint reader.

18. An electronic device and a control device according to claim 17, wherein the fingerprint reader has a fingerprint pad within a surface of the control device.

19. An electronic device and a control device according to claim 16, wherein the electronic device is a set top box for a television receiver, and the control device is a remote control device for operating the set top box.

20. An electronic device and a control device according to claim 19, wherein the remote control device is uniquely paired to the set top box in that biometric data collected by way of the biometric reader in the remote control device has been stored in the set top box to identify the authorised user.
